(19) United States
(12) Patent Application Publication
(10) Pub. No.: US 2017/0329015 A1
(43) Pub. Date: Nov. 16, 2017

(54) METHOD AND SYSTEM FOR TRACKING RACE PARTICIPANTS

(71) Applicant: Sports Information Services Limited, Milton Kenynes (GB)

(72) Inventors: Alistair Clare, Milton Keynes (GB); Adam Charles Castell, Milton Keynes (GB)

(73) Assignee: Sportss Information Services Limited, Milton Keynes (GB)

(21) Appl. No.: 15/531,386

(22) PCT Filed: Nov. 30, 2015
(86) PCT No.: PCT/GB2015/053656

§ 371 Date: May 26, 2017

(30) Foreign Application Priority Data
Nov. 28, 2014 (GB) 1421217.9
Dec. 5, 2014 (GB) 1421676.6

(51) Int. Cl. G01S 19/19; G07F 17/32; G01S 19/36; G01S 19/24

(52) U.S. Cl. CPC G01S 19/19; G07F 17/3288; G01S 19/24; G01S 19/36; G07F 17/323

(57) ABSTRACT

Embodiments of the invention provide a method and system that allows for GNSS tracking of race participants in a race. Wireless enabled GNSS receivers monitor the position of race participants during a race and transmit position back to a central aggregating unit using a TDMA radio frame structure. The central aggregating unit provides the position data as a repeated data feed during the race to a mapping device that converts the 2D position data to one dimensional race data, showing position of race participants along the race course from start to finish. This one dimensional data may be directly output to end users, and/or used to calculate various “in-game” probabilities of outcomes of the race. The probabilities may then be output to end user, for example for betting or other gaming purposes.

### TECHNICAL FIELD

Embodiments of the present invention provide a method and system, and associated apparatus, for tracking the position of race participants during a race. In particular, some embodiments of the invention are directed at the tracking of the position of horses during a horse race, and of calculating and providing in-race data relating to the performance of the horses during the race.

### BACKGROUND TO THE INVENTION AND PRIOR ART

Horse racing is a heavily regulated sport, carefully controlled in most countries for the well-being of the horses and to ensure fairness to spectators who may be gambling on the outcome of the races. Whilst position tracking in various athletic sporting events is known, heretofore position tracking in horse races has not been adequately performed by validated systems which have the approval of local horse racing regulatory bodies. There is therefore a need for more accurate horse racing tracking systems that meet with the appropriate regulatory approval.

### SUMMARY OF THE INVENTION

Embodiments of the invention provide a method and system that allows for GNSS tracking of race participants in a race. Wireless enabled GNSS receivers monitor the position of race participants during a race and transmit position back to a central aggregating unit using a TDMA radio frame structure. The central aggregating unit provides the position data as a repeated data feed during the race to a mapping device that converts the 2D position data to one dimensional race data, showing position of race participants along the race course from start to finish. This one dimensional data may be directly output to end users, and/or used to calculate various “in-game” probabilities of outcomes of the race. The probabilities may then be output to end user, for example for betting or other gaming purposes.

From one aspect embodiments of the invention provide a tracking device, comprising a casing; and electronic components, comprising at least: a GNSS module, comprising a GNSS antenna; and a GNSS data processing module; the device further comprising a substantially planar GNSS ground plane; wherein the electronic components are arranged in a substantially planar array; and wherein the GNSS ground plane has a width in its plane greater than the width of the planar array of electronic components.

Embodiments of the invention provide a tracking device comprising internal electronics and an external antenna. The device preferably has a flexible outer casing and the internal electronics are preferably spaced from one another and connected by flexible electrical connections, to permit movement relative to one another upon flexure of the outer casing. The internal electronics are preferably separated by spacing means, which are preferably flexible and preferably integrally formed parts of the casing.

The device preferably further comprises a data conductor for connecting an external data transmission component to transmit data received from the GNSS (global navigation using satellites) module.

The casing preferably surrounds the electronic components and the GNSS ground plane on all sides. The device preferably further comprises at least one battery and/or a data transmitter module.

The device may further comprise an antenna connector arranged for connection of an external antenna to the data transmitter module.

The device may comprise a data transmitter module contained within the casing, arranged to transmit the GNSS data via radio frequency signals to an antenna, via the data conductor.

The device may further comprise an antenna connector, arranged for connection of an external antenna to the data transmitter module.

The device may be configured to transmit data to an external data transmission module via the data conductor, for conversion to radio signals externally to the device.

A tracking device according to any of the preceding claims, wherein the GNSS ground plane has a width in its plane more than two times the width of the GNSS antenna module, preferably more than two and a half times the width of the GNSS antenna.

At least the casing may comprise a resilient flexible material, preferably a rubber-based resilient material, such as neoprene. The material is preferably substantially waterproof and may be bonded with a woven fabric. The material may be a foamed material. The material preferably provides a shock absorbent flexible casing to at least one of the internal electronic components.

The resilient flexible material may have a shore durometer hardness of between around 1 to 100, preferably around 10 to 100, more preferably around 30 to 100, more preferably around 40 to 80, even more preferably around 50 to 70, all values+/−5. All integer values within these ranges may be beneficial in certain implementations.

The flexible resilient material may be capable of an elongation of between around 100% to 350%, preferably 200% to 300%, without break.

The casing preferably comprises a plurality of spaced component receiving portions, preferably recesses, for receiving one or more of the electronic components in spaced configuration relative to one another.

The electronic components are preferably connected by flexible electrical connections, such that flexure of the flexible casing can induce movement of the electronic components relative to one another.

The casing preferably comprises spacing portions, preferably resilient spacing portions, disposed between the electronic components to substantially prevent mechanical contact between the electronic components.

The tracking device preferably comprises a substantially planar GPS ground plate for the GPS module comprises a conductive flexible sheet. The GPS ground may comprise a mesh.

The casing preferably comprises first and second substantially planar casing parts, which surround the electronic components when assembled together.

The GNSS ground plane may be mounted to a flexible chassis. At least one of electronic components may be mounted to a flexible chassis plate within the casing.

The casing may comprises first and second substantially planar casing parts, which surround the electronic components when assembled together.

The invention further provides a tracking device comprising internal electronics comprising a GNSS antenna and a planar flexible GNSS ground plane; the device comprising a flexible casing surrounding the internal electronics and the flexible chassis. The internal electronics may be mounted to a flexible chassis within the flexible casing.

The tracking device may have a ratio of its greatest dimension in a first plane to its greatest dimension in a second plane of greater than 5:1, preferably greater than 8:1, more preferably greater than 10:1, more preferably greater than 14:1. This may be a width to height ratio of the device.

Another embodiment of the invention provides a location determining device, comprising: a GNSS receiver; a controller; and a wireless transceiver, the controller being arranged to receive position data from the GNSS receiver, and to control the wireless transceiver to transmit at least a subset of the position data in a TDMA timeslot of a TDMA frame defined by receipt of a data burst from a separate transceiver to which the position data is to be transmitted.

In one embodiment the GNSS receiver passes GGA data strings to the controller, and the controller is arranged to truncate the received GGA data strings such that the position data transmitted consists essentially of time, latitude, and longitude data.

In another embodiment the transmitted position data is further compressed prior to transmission.

From another aspect, embodiments of the invention also provide a device, comprising, a controller, and a wireless transceiver, the controller being arranged to control the wireless transceiver to transmit a data burst defining the start of a TDMA frame structure, the transceiver then listening throughout the frame structure to data bursts from remote units containing GNSS position data of the remote units, the controller acting to aggregate the respective position data and output it as a data feed.

A further aspect of the invention provides a race event monitoring system, comprising: a processor; a computer readable storage medium storing one or more computer programs, the computer programs operable when executed by the processor to cause the processor to operate in accordance with the following method: receive two-dimensional geographic location data relating to the location of participants in a race event on a race track hosting the event; determine one-dimensional position data of the participants indicative of relative position of the participants along the race track between start and finish points of the race event; and outputting the one-dimensional position data as a data feed.

In one embodiment the method steps are repeated throughout the duration of the race event to provide one-dimensional position data throughout the duration of the event.

One embodiment further comprises using the one-dimensional position data to generate one or more race variables, comprising one or more of:
i) time expended;
ii) distance travelled;
iii) distance remaining;
iv) race speed; or
v) current speed.

In one embodiment the race variables are combined with a priori participant specific performance variables, to calculate a probability distribution matrix of possible race results. Preferably the probability distribution matrix is used to calculate the probabilities of one or more of:
i) Who will finish in the quickest time (race winner);
ii) Who will finish in the three quickest times (to be placed);
iii) Horse A to finish quicker than horse B (match bet); or
iv) Who will finish quickest ignoring horse A (betting without the favourite).

In one embodiment the calculated probabilities are provided to users over a network connection.

Further aspects, features, and advantages of embodiments of the present invention will be apparent from the appended claims.

### BRIEF DESCRIPTION OF DRAWINGS

Embodiments of the present invention will now be described by way of example only, and with reference to the accompanying drawings in which like reference numerals refer to like parts, and wherein:

FIG. 1 is a block diagram of the system elements in an embodiment of the invention;

FIG. 2 is a block diagram of one of the system elements of FIG. 1;

FIG. 3 is a flow diagram illustrating the operation of one of the system elements;

FIG. 4 is a flow diagram illustrating the further operation of one of the system elements;

FIG. 5 is a diagram illustrating the network architecture used in an embodiment of the invention;

FIG. 6 is a diagram illustrating a TDMA frame structure in an embodiment of the invention;

FIG. 7 is a system block diagram of a communications unit in an embodiment of the invention;

FIG. 8 is a diagram of an antenna arrangement used in an embodiment of the invention;

FIG. 9 is a diagram of an antenna arrangement used in an embodiment of the invention;

FIG. 10 is a flow diagram of a software process used in an embodiment of the invention;

FIG. 11 is a diagram illustrating the different types of interrupts used in the software of an embodiment of the invention;

FIG. 12 shows an exploded view of a tracking device of the invention;

FIG. 13 shows a plan view of internal components of the tracking device of the invention;

FIG. 14 shows a first side section view of the device of the invention;

FIG. 15 shows a second cross-sectional view of the device of the invention;

FIG. 16 shows an external view of the device of the invention;

FIG. 17 shows an illustration of the flexible casing of the invention;

FIG. 18 shows a view of the device of the invention with the casing in an opened configuration;

FIG. 19 shows different relative sizes of possible configurations of the invention; and

FIG. 20 shows an external view of an example of the device of the invention

### DESCRIPTION OF PREFERRED EMBODIMENTS

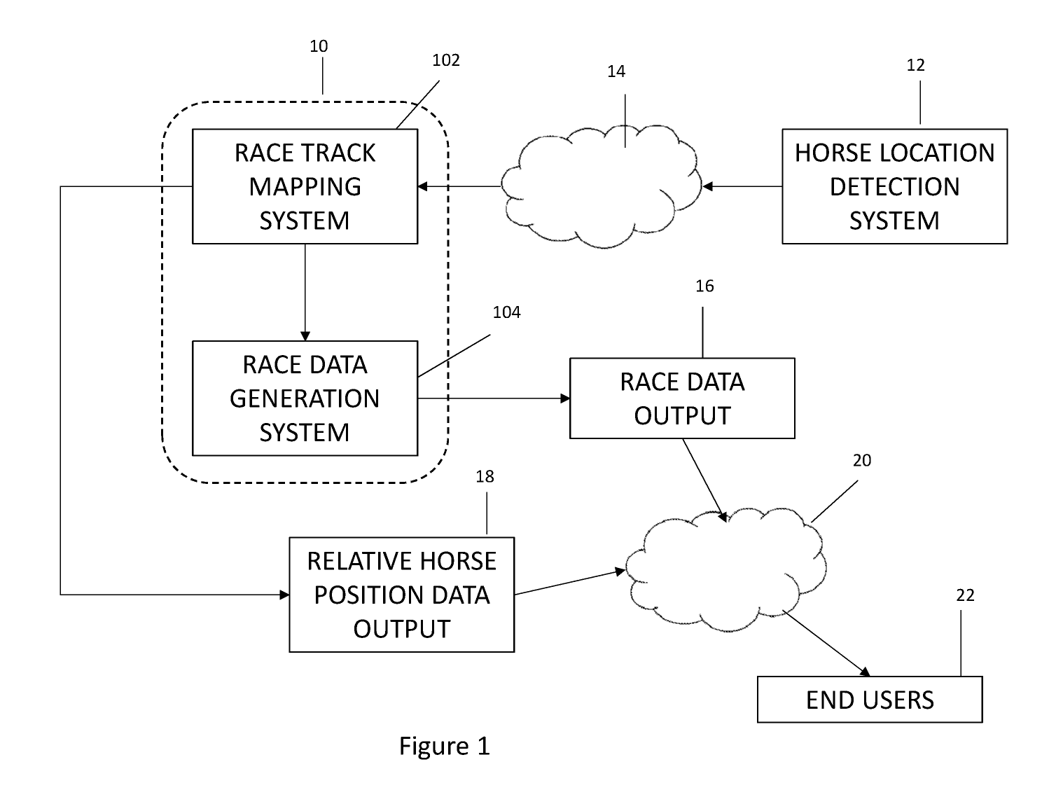

FIG. 1 illustrates a block diagram showing the overall system of embodiments of the invention. The overall system of embodiments of the present invention provides a race tracking system, which tracks the position of participants in a race, and generates data concerning the participant's performance in dependence thereon. The data includes data showing the relative positions and absolute positions of the race participants with respect to each other, and also other data pertaining to the race, such as probabilities relating to which participant will win the race, and which participant will achieve particular positions in the race. Further race data that may be calculated includes odds of a particular participant winning the race, or gaining a particular place. Embodiments of the invention are particularly directed at providing data relating to horse races, and particularly data that can be used in a gambling environment, such as, for example, gambling odds of a particular horse winning a race, or achieving a particular place, or range of places. The embodiments of the invention to be described, therefore, will focus on the application of the invention to horse racing, although it should be noted that in other embodiments of the invention this is not necessarily the case, and other embodiments may find application in other sporting environments, such as athletics races, motor racing, and the like.

Referring to FIG. 1, embodiments of the present invention provide a horse location detection system 12, which itself is a radio connected multi-unit system, arranged in a point to multi point star network configuration with remote units mounted on individual race participants, communicating with a central hub unit that collects position data from the remote units, and aggregates it for output. Further details of the horse location detection system 12 will be given later. For the time being, however, the horse location detection system 12 provides an aggregated data feed relating to the position of participants in a race, the data feed typically comprising the absolute position, for example the latitude and longitude obtained from a GNSS system, of each race participant, which is then aggregated and provided as a data feed over a network 14 such as the Internet, to race analysis system 10, that comprises a racetrack mapping system 102, and a race data generation system 104.

The racetrack mapping system 102, forming part of the race analysis system 10, receives the aggregated position data feed from the horse location detection system 12, and acts to map the absolute locations of each race participant onto a two dimensional map of the race course along which the race is being undertaken. The mapping system then undertakes a transformation of the 2D positional data of the racecourse into a one dimensional representation showing how far along the race track each race participant presently is, and thereby allowing for easy determination of the relative positions of each race participant. This one dimensional positional data may then be output as output data 18, for example over the Internet 20 as a data feed to one or more end users. The end users in this case who may wish to receive this data feed may be, for example, sophisticated bookmakers who will then use the position data represented by the one dimensional data feed so as to calculate their own in-race odds of particular events occurring, such as a particular horse winning a race, or achieving a particular place.

For less sophisticated end users, the one dimensional race data may be passed to a race data generation system 104, which itself then processes the data to calculate a number of variables for every horse at all times during the race. For example, variables such as time elapsed, distance travelled, distance remaining, race speed, and current speed may be obtained. The variables may also be combined with horse specific parameters that have been determined in advance, to calculate further in-play variables to create an expected race completion time for every horse, and a probability distribution of these times. By “in-play” or “in-game”, we mean that variables relating to the outcome of the event are calculated whilst the event is being undertaken i.e. after the start of the race but before it has ended.

The probability distribution of times may be used by the race data generation system 104 to calculate a probability matrix, containing probabilities for which participant will finish in the quickest time, which participants will finish in the three quickest times, whether a particular participant will be faster than another particular participant, who will finish quickest ignoring a particular participant, etc. etc. This probability matrix may be published as race data output 16 every few seconds, typically every 3 to 5 seconds, and supplied as a data feed via the Internet 22 to subscribing end users 22. These subscribing end users 22 may, for example, be independent book makers and the like who will then be able to use the information directly to provide in-game or in-play odds to customers during the race itself. Further examples of the selection of data provided as the race data output 16 to end users 22 will be given later.

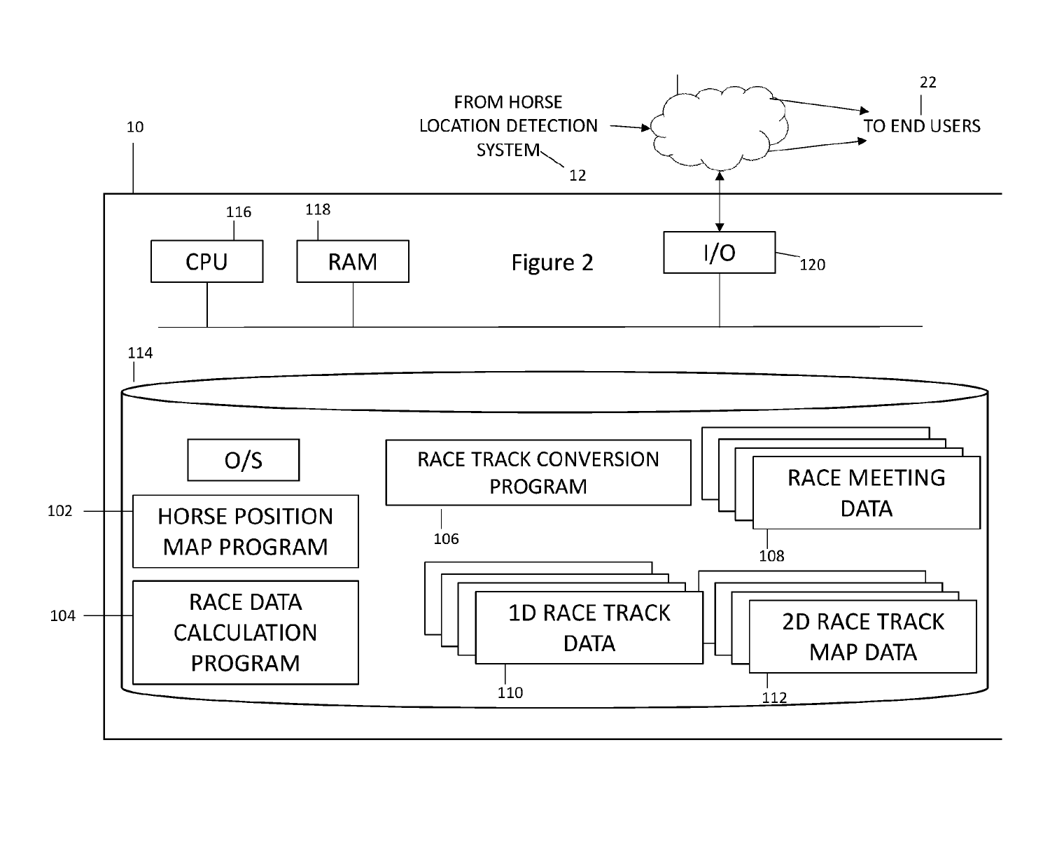

FIG. 2 is a block diagram of the race analysis system 10. In this embodiment, the race analysis system 10 is implemented on a general purpose computer system, having a central processing unit 116, random access memory 118 for storing executable programs and data, and one or more input and output ports 120 for receiving input and providing output via various user input and output devices. In this case, the input and output port 120 also provides a network connection via the Internet 20, so as to receive a data stream from the horse location detection system 12, as described previously, and to be described in more detail later, and to provide data output to the end users 22, as described above. Also provided as part of race analysis system 10 is a computer readable storage medium 114, such as a hard disk drive, solid state drive, flash storage, or the like, upon which is stored the operating system for the system 10, as well as various control programs and data specific to the present embodiment.

More particularly, horse position map program 102 is provided that in use acts to receive the data feed from the horse location detection system 12, map the individual horse locations onto two dimensional racetrack data, and convert the plotted two dimensional positions into a one dimensional representation showing how far each race participant is along the race-course from beginning to end. This one dimensional representation may be output via the I/O port 120 and Internet 20 to end users 22 as a data feed, and is also provided as an input to race data calculation program 104, to be described. The horse position map program 102 makes use of racetrack conversion program 106 to convert 2D racetrack map data 112 for the particular track upon which a race is being run into 1D racetrack data 110. That is, racetrack conversion program 106 is called by horse position map program 102 so as to access the 2D racetrack map data 112 for a particular racecourse upon which a race is presently being run, and to convert it into 1D racetrack data 110 for the particular racecourse. Also provided is race meeting data 108, which is data relating to particular race meetings and races thereat, such as, for example, definitions of the length of each race, the starting and end positions along a racecourse of each race, the position of fences, and the names of individual horses in each race. The horse position map program 102 also uses the race meeting data, and in particular the race start, end, lap number and fence position data, in order to calculate the position of race participants along the racecourse so as to generate the one dimensional race representation.

Also provided is race data calculation program 104, the race data calculation program 104 receives the one dimensional race representation from the horse position map program and calculates several variables for each race participant repeatedly during the race. In particular, the variables calculated include:
time elapsed,
distance travelled,
distance remaining (which equals the race distance minus the distance travelled),
the race speed (which equals the distance travelled divided by the time elapsed) and
the current speed which is equivalent to the metres travelled in the last X seconds, where X is, for example, 5, 10, 20, and 30.

In addition, the race data calculation program also calculates a probability distribution for each competitor of expected race completion times, and then the probability distribution is used to calculate various race possibilities. The probability distribution and the various race possibilities calculated by the race data calculation program 104 are fed via the I/O port 120 and the Internet 20 to end users 22. End users 22 in this case may, for example, be independent book makers and the like, who will then make use of such data for their book making business activities. Specifically, the provision of the data allows independent book makers to provide “in-race” odds; that is, to allow bets to be taken at particular odds calculated in dependence upon the in-race data provided by the system whilst the race is actually in progress. Traditionally, book makers would typically close their books on a race once the race had started, and in-race betting was not usually possible.

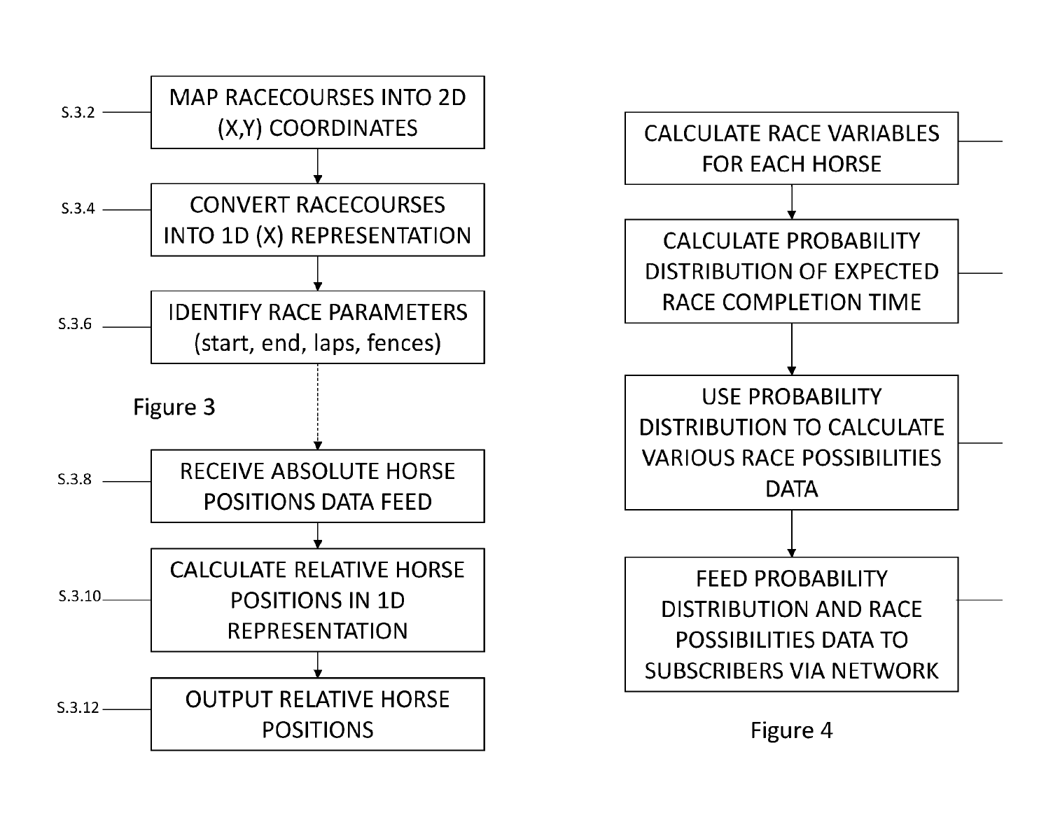

FIG. 3 is a flow diagram illustrating the operation of the horse position map program 102. The operation of horse position map program 102 can be performed in two parts, with steps 3.2 to 3.6 being provided for processing before a race has commenced, whilst steps 3.8 to 3.12 are performed during a race, to provide in-race participant position data. Firstly, at step 3.2, the horse position map program accesses the stored two dimensional racetrack map data 112. The two dimensional racetrack map data 112 is two dimensional map data of at least a variety of racecourses, including the present racecourse at which races are to be run. The data may be obtained from various electronic mapping data sources and the data will represent the whole racecourse in two dimensions showing the shape of the racecourse and its length.

For use in the embodiment of the present invention, however, the horse position map program 102 uses the racetrack conversion program 106 to convert the two dimensional racetrack map data into a one dimensional representation of each racetrack. In this respect, to try and determine whether a horse is winning a race, it is merely necessary to determine the order of horses from start to finish along the track, as if the track was a straight line i.e. extended in one dimension. Embodiments of the present invention therefore simplify the processing required to determine which horse is wining by converting the two dimensional racecourse layout into a one dimensional representation which maps the length of the racecourse from start to finish around the course to a single dimension. Effectively, the conversion that is performed acts as if a curved racecourse was being straightened into a straight line, such that the participants run only in a straight line, rather than around the actual course. The conversion can therefore be thought of as unfolding or unrolling the two dimensional shape of the course into a straight line along which the horses run. The 1D racetrack data 110 is stored for each racecourse at which races are being run on the computer readable storage medium 114.

Note that it is not necessary to perform the 2D to 1D conversion de novo for every race meeting, and that once a 1D representation of a racecourse has been generated by the racetrack conversion program, then it can be reused for subsequent race meetings at the same racecourse. Hence, step 3.2 and step 3.4 need not be performed separately individually for every race, or even for every race meeting. What is necessary to obtain for each individual race, however, are the individual race parameters stored as the race meeting data 108. The race parameters will be individual to each race that is run, and will specify the start and end points along the racecourse, the number of laps of the racecourse to be run, and the position of fences along the racecourse in the case of National Hunt racing. Of course, where the racecourse is flat, the fence positions may be omitted. The individual race parameters are used by the horse position map program 102 during the race at steps 3.8 to 3.12, so as to be able to calculate the relative positions of the horses along the length of the course for a particular race being run.

Steps 3.8 to 3.12 describe the actions of the horse position map program whilst a race is being run. In this case, during a race the horse location detection system 12 described in more detail later provides an aggregated data feed comprising a stream of data with the two dimensional map positions, typically in latitude and longitude co-ordinates, of each horse in a particular race. This data stream is received from the horse location detection system 12 via the Internet 20 into the I/O port 120, and fed to the horse position map program 102 when executed by the CPU 116 during a race. The horse position map program 102 parses the data stream to determine the absolute horse positions in a particular race, at step 3.8. The absolute horse positions in two dimensions are then converted into one dimensional representations to be able to plot each position against the one dimensional racetrack data 110, such that the relative horse positions to each other, and with respect to the start and end points of the race can then be determined. This calculation step is performed at step 3.10, and provides an indication for each race participant, as to how far the participant is along the track between the start and end points of the race. This one dimensional representation therefore allows for a much clearer representation of the relative positions of the participants with respect to each other, and which participant is in the lead and/or in front of other participants. The transformation of 2D horse position to 1D relative position is performed in the same way as the original transformation of 2D race course map data to 1D race course representation.

The one dimensional relative horse positions are then output by the horse position map program at step 3.12, and may be fed via the I/O port 120 in the Internet 20 to end users 22, who desire this information, for example to calculate their own betting odds and the like. Such users would typically be large, sophisticated book makers who wish to use the relative horse position data for their own book making purposes, which purposes are beyond the scope of the present application. In addition, however, the relative horse position data is also output to the race data calculation program 104, the operation of which will be described next with respect to FIG. 4.

Note that the horse position map program 102 operates repeatedly during a race, to provide a repeated feed of relative horse positions which are output as a data feed to end users. Hence, the relative horse position data in one dimension is provided as a data feed, updated every 3 to 5 seconds, for example, to end users, and also provided at the same rate to the race data calculation program.

FIG. 4 illustrates the operation of the race data calculation program 104. With reference to FIG. 4, at step 4.2 the race data calculation program 104 controls the CPU 116 to calculate race variables for each horse, in dependence on the one dimensional horse position data received from the horse position map program. This data is calculated repeatedly every few seconds throughout the race, and includes:
time elapsed,
distance travelled,
distance remaining (which equals the race distance minus the distance travelled),
the race speed (which equals the distance travelled divided by the time elapsed), and
the current speed (which equals the metres travelled in the last X seconds, where X is, for example 5, 10, 20, or 30).

These variables are then combined at step 4.4 with two horse specific parameters that are calculated in advance, and which relate to a speed rating and a stamina rating of an individual horse to create an expected race completion time for every horse, and the probability distribution of these times. The speed rating and stamina rating may be calculated in advance based on previous performance statistics for a particular horse, or may be estimated, for example on a scale of 1 to 10, by expert racing pundits. Generally, however, the calculation of these two horse specific parameters is beyond the scope of this description, suffice to say that two horse specific input variables are used as inputs to the system of the present embodiment.

The calculated probability distribution is then used to calculate a probability matrix for each horse at step 4.6, to calculate various race possibilities. For example, these possibilities may include the probabilities of:—
Who will finish in the quickest time (race winner)
Who will finish in the three quickest times (to be placed)
Horse A to finish quicker than horse B (match bet)
Who will finish quickest ignoring horse A (betting without the favourite)
And others.

At step 4.8 the probability distribution and the race possibilities data calculated at step 4.6 is then fed via the I/O port 120 and the Internet 20 to subscribing end users 22, every X seconds, where X is typically in the range of 3 to 5. If a horse is registered as a “faller” in between these publishing intervals, then that too should be immediately published.

In terms of use of such a data feed, an operator such as an independent bookmaker is able to subscribe to this published data through the data feed provided over the network 20. The feed may be filtered for each operator to match their needs, and the data available will usually be listed in the following hierarchy:

### Sport

### Country

### Meeting

Event/race time

### Type

### Distance

### Selection

### Market

### Probability

Margin-less price (equals 1/probability)
Margined price—decimal (probability put through any predetermined book keeping margining function)
Margin price—fractional (decimal margined price minus 1 expressed as a fraction)

For example, the data feed may provide a data structure such as the following:—

Horse racing

### UK

### Aintree

2:35

### Flat

2 miles, 3 furlongs

### Red Rum

Race winner
0.34
2.94
2.75 (note that the margined price is less than the marginless price, the difference representing the book-keepers margin)
7/4

With the above system, therefore, less sophisticated end users such as independent book makers and the like, are able to provide “in-game” odds on particular events such as a particular hose winning. That is, they are able to take bets on particular outcomes after the race has started whilst the race is running, taking into account the positions of the horses at that time during the race. Heretofore, such in-game betting has been very difficult, and particularly for independent bookmakers, to provide.

Further details of the horse location detection system 12 will now be described. The horse location detection system 12 (or more generally, Sports Tracking System (STS)) was designed to enable the position tracking of a number of objects (remotes) in a relatively clear space with reasonable accuracy and update rate. The position is reported to a central site and presented as an ASCII string on a serial line.

In terms of the performance requirements of some embodiments of the invention, the range between the central site and the remotes should be maximised, but with a minimum of about 1500 m. Size, weight and power should be minimised, and ideally any radio used for data transfer should be licence exempt. The number of remotes should be maximised, but with a target of at least 20. Accuracy should be at least in the order of 300 mm, with an update rate of at least 10 position reports per second. Ideally a low dependence on fixed infrastructure should be achieved: the system should be quick and inexpensive to install.

### System Overview

The embodiments of the invention relating to the tracking of participant position during a race have two main system components: i) a positioning system to determine the position of a participant along or within the race course, and ii) a radio communications system to communicate the position. Various design considerations of each are considered below.

### Positioning Technology

Initially some consideration was given to harmonic radar, and radar reflection systems. Cost, speed of implementation, speed of update and overall complexity effectively ruled those out. Radio direction finding was also ruled out, due to accuracy, complexity and speed of update. A global navigation satellite system (GNSS) solution was therefore adopted, as a reasonably low risk, low cost strategy. Other systems could provide similar accuracy, but would require more infrastructure and would be a higher risk approach.

Selection of a GNSS module for integration was achieved by the formation of a matrix in which accuracy, size, weight, power consumption, update speed, flexibility and cost were evaluated. Some embodiments of the invention described later make use of the NV08C-CSM GNSS module available from NVS Technologies AG, and described at http://www.nys-gnss.com/product/receivers/items/2-nv08c-csm.html.

### Radio Technology

The field of choice for the radio system was wide. Initial consideration was given to fully meshed networks, but given the requirements for low power, license exemption, the available bandwidth would not support the data throughput requirement. In addition, the latency would be significant. Other options such as wi-fi were ruled out due to infrastructure requirements and power budget. GSM was considered, but ruled out, due to power budget together with potential network capacity and latency issues. A single hop star network was eventually selected. To minimise spectrum usage, a TDMA (Time Division Multiple Access) system, which would allow multiple transmitters to use the same frequency at different times, was designed. The frequency of the system was chosen as 868 MHz as this provided the best trade-off between antenna size, blockage risk and bandwidth. To minimise the cost of development and to leverage existing approvals, it was decided to use a pre-existing radio module. In embodiments of the invention a wireless module from Amber Wireless GmbH was selected. For example, the Amber AMB8350 wireless module, described at http://amber-wireless.de/62-1-AMB8350.html, has one of the best link budgets of its type. It also provides the ability to adjust many more of its parameters than other similar modules.

### System Description

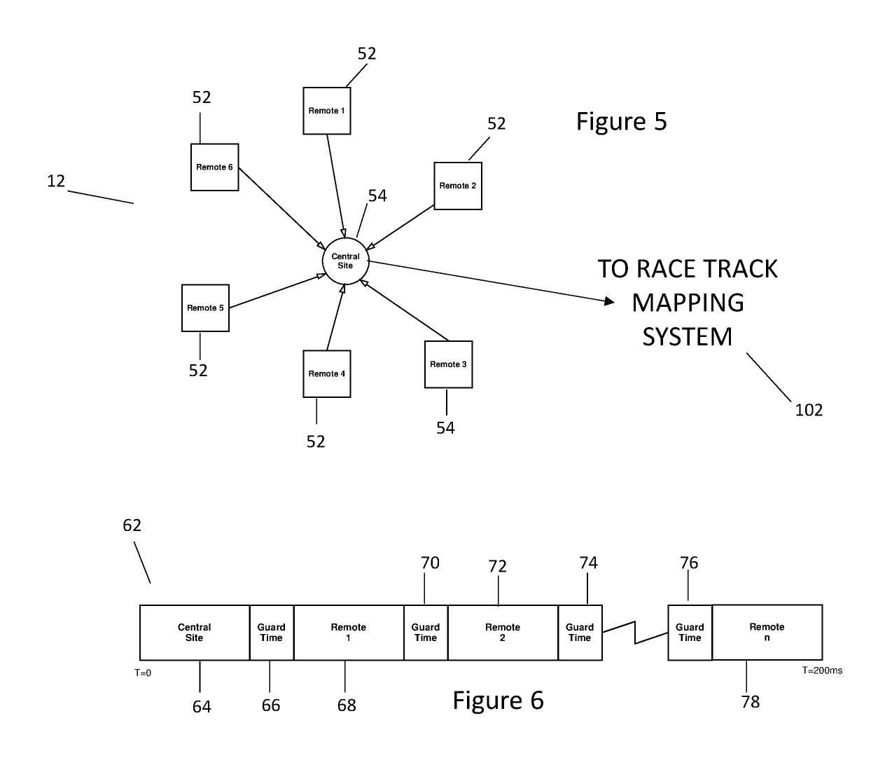

Conceptually, the system of embodiments of the invention is a star network on a single carrier frequency, using time division multiple access (TDMA). An example star network is shown in FIG. 5, where multiple remote stations 52 communicate with the central hub 54. The central hub 54 aggregates the data from the remote stations 52, and provides a data feed to the race track mapping system 102, as described previously.

An example TDMA frame of the invention is shown in FIG. 6. The TDMA frame is repeated every 200 ms, giving a 5 Hz position update rate. This provides an acceptably low temporal granularity and remains within the bandwidth constraints. The position sample is taken at the same time on every remote, so the relative position between remotes is correct. The maximum latency is less than 200 ms.

The TDMA timing synchronisation is derived from the GNSS network. The central unit broadcasts a data burst (64), then sequentially all remotes send their position to the central site in respective bursts (68, 72, 78), separated by appropriate guard times (66, 70, 74, 76). The time slots within the TDMA frame for the individual remote devices are predefined in advance, and do not vary from frame to frame. Hence, a particular remote may be allocated a transmission order number in the frame, and will listen to the channel for bursts from the central unit and other remotes with higher order numbers until its turn comes to transmit its own burst. Thus, for example, if a particular remote is allocated order number 5, then the remote will listen for the frame start burst from the central unit, and will then listen to 4 bursts from other remotes, constituting earlier time slots in the present frame before then transmitting its own data burst in its allocated time slot i.e. the fifth slot.

Alternatively, rather than listening to and counting bursts from other remote units, instead a remote can start a timer from the receipt of the frame start burst from the central unit, that counts a predetermined length of time from the start of the frame (or the end of burst from the central unit) until the predefined transmission slot is reached. For example, with a 200 ms frame structure, and 9 remote devices, with the central unit taken into consideration there should be 10 slots in the frame required, allowing 20 ms per device. If a 10% guard time (i.e. 2 ms) is used between each slot then each slot is 18 ms long, plus the 2 ms guard. For a remote device that has been pre-configured to transmit in the fifth position in the frame, for example, its timer should count 100 ms (comprising the 18 ms central unit burst, 2 ms guard time, 18 ms first remote unit burst, 2 ms guard time, 18 ms second remote unit burst, 2 ms guard time, 18 ms third remote unit burst, 2 ms guard time, 18 ms fourth remote unit burst, 2 ms guard time), before starting its own transmission. By so doing, it will ensure that it transmits in its own pre-assigned slot in the TDMA frame.

The more the position data can be compressed, the more remote slots there can be in the TDMA frame. The central site transmission, which is broadcast to all remotes, provides a mechanism for GNSS corrections or other data to be transmitted to the remotes. The data received by the central site is simply passed through and presented as an RS232 serial data stream for subsequent processing by an application.

### Hardware

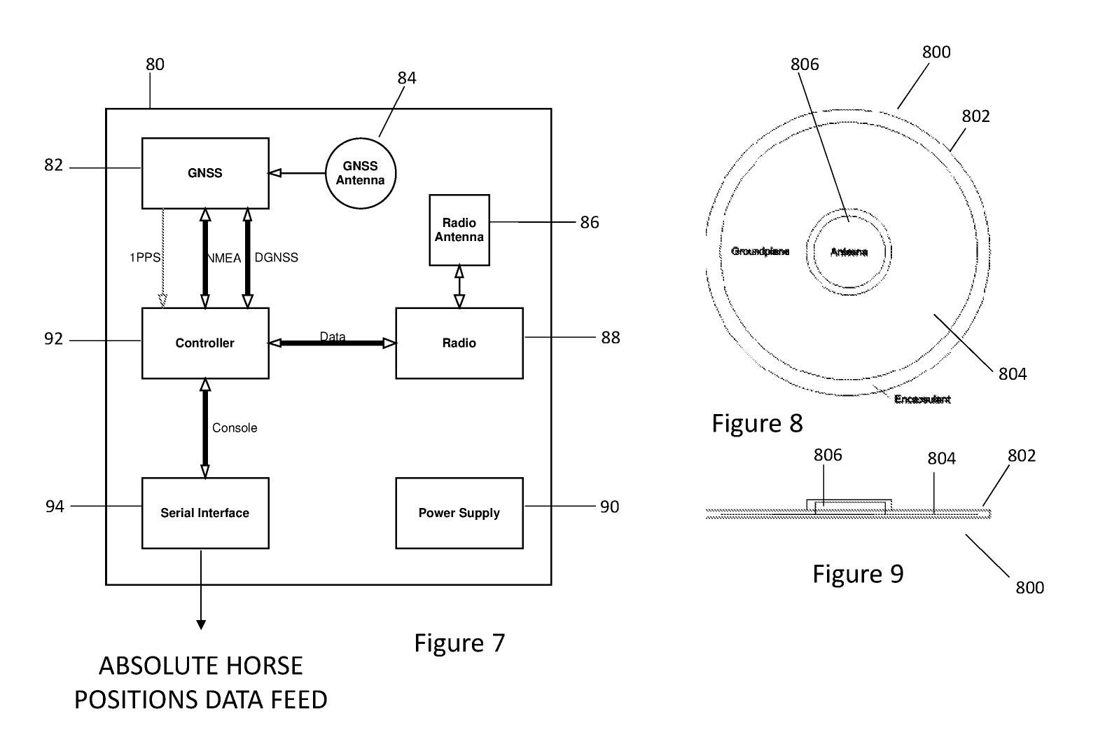

FIG. 7 shows a hardware block diagram for the system elements. The hardware is electronically identical for both the remote and central units. Packaging and interfaces change according to the application. The system units 80 comprise a GNSS (GPS) module 80, that receives an RF signal from GNSS antenna 84 (806 in FIG. 8), described in more detail later. The GNSS module outputs position and timing data to the controller processor 92, that acts to control the radio module 88, for example in the case of remote units to transmit the position and timing data to the central hub unit 54 in accordance with the TDMA protocol described above, and in the case of the central hub unit 54 to initiate the TDMA frame, and then to receive the TDMA bursts from the remote unit. A serial interface 94 is provided, which when the unit is being used as the central hub unit is used to output the horse positions data stream. A power supply 90 is also included to provide power to the system modules, and a radio antenna 86, to permit communication between the hub unit and respective remote units.

Various aspects of the different system components will be discussed in more detail below.

### GNSS Antenna

During testing, it was noted that the accuracy of the GNSS module was heavily influenced by the antenna being used. It became obvious that the larger antennae were the better performers. In the target embodiment, a large antenna was not an option, either in terms of size or weight. After some research and experiment, it was found that the size, weight and performance could be significantly improved over either a large GNSS antenna, or a small patch antenna. This was done by using a relatively high performance antenna module, together with a flexible conductive ground plane, moulded into a flexible waterproof module. FIGS. 8 and 9 show that a GNSS (e.g. GPS/GLONASS/Galileo) antenna 806 is provided with an extended circular groundplane 804, extending several, for example 2 to 6, diameters of the circular antenna. The whole arrangement is then encapsulated within an encapsulant 802, such as neoprene, to provide protection. Additional details of the antenna arrangement and encapsulant will be given later.

### Radio Antenna

The radio antenna 86 for remote units is a commercial off-the-shelf (COTS) antenna, that should be selected for size and performance—it does not require a ground plane, is thin and flexible. The central site antenna needs to be selected according to the environment the system is deployed in, to ensure coverage of the roaming area. Because the central site antenna is fixed, and will not be carried by a race participant, it can be larger with higher gain than the remote unit antennas to maximise the link budget.

### GNSS

The GNSS module 82 (in some embodiments a NV08CSM, from NVS Technologies AG) may be configurable so that only the GNSS string(s) of interest are generated. This reduces the load on the processor, as redundant data does not need to be filtered. The data is presented as a logic level serial stream. A second serial port on the module can be used for either correction data using RTCM V2 or raw phase data correction. There is a one pulse per second output pin, which is synchronised to the GNSS network. This is used to generate a hardware interrupt on the processor 92; the use of interrupts will be described later.

### Radio

The radio module 88 uses a serial data line to communicate with the processor 92. There are a number of control and status lines, some of which are also available. Again, by using an addressing mode which means that only the central site broadcasts are received, the processor overhead is reduced.

### Processor

A controller processor 92 is provided, as shown in FIG. 7. The most unusual requirement of the processor 92 in some embodiments was the need for four serial ports; two for GNSS, one for radio, and one for configuration (and data streaming for the central site). Other than that in some embodiments it may be a standard Microchip® PIC, available for example from Microchip Technology Inc, and selected for low power consumption and familiarity.

### Power

The power supply 90 is in some embodiments a standard buck/boost design, used to maximise the useful life of two AA batteries. All the hardware elements were selected to minimise power consumption, thus increasing the battery life of the remotes. In other embodiments further power management could be implemented; the anticipated power reduction might amount to 5% increase in battery life. In other embodiments other power circuit designs, such as a flyback converter, may be used.

### Software

The controlling software running on the PIC 92 consists of a main loop which processes the various communications buffers and an interrupt service routine, which fills the communications buffers as data arrives. The processor's main tasks are to direct data to the appropriate destination, compressing data where appropriate, and complying with the TDMA system timing requirements.

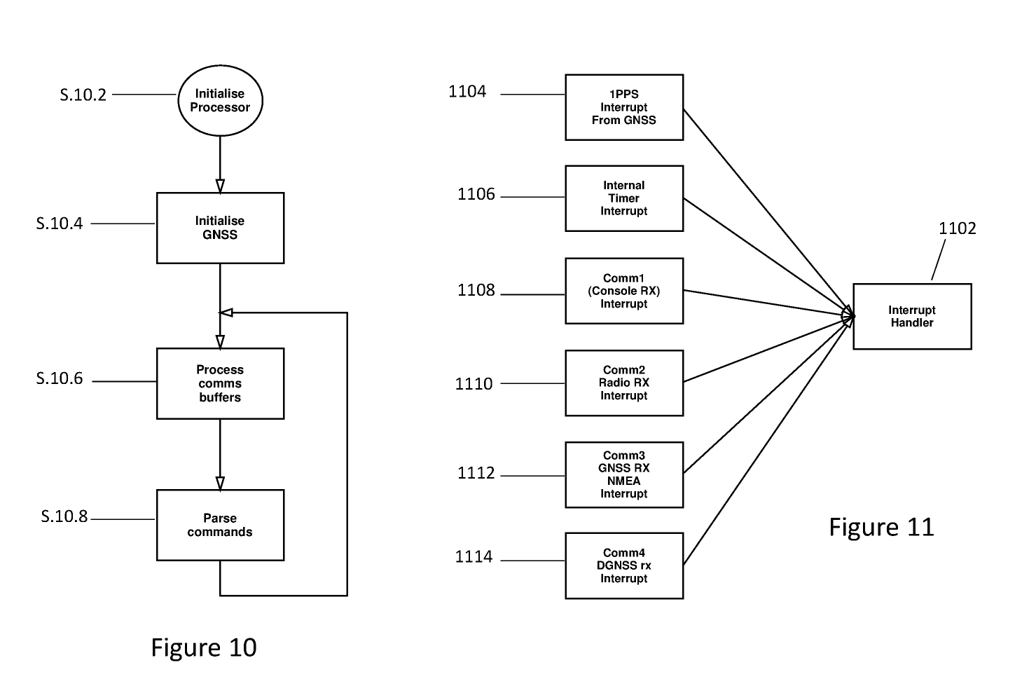

FIG. 10 illustrates an overall process diagram for the software. At step 10.2, the processor 92 is initialised, and then at step 10.4 the GNSS module 82 is also initialised, such that thereafter it is able to provide a stream of position fix data to the processor 92. A processing loop comprise steps 10.6 and 10.8 is then entered, which runs continuously until power down, with step 10.6 looking at a number of communications buffers to see if any data has been received thereon, and step 10.8 acting to parse any received data to determine if a valid command has been received, and to then act on it if so. Further details are given below.

Regarding the radio, note that the radio is not explicitly initialised at power up—it initialises itself according to its last configured profile. If the system is reconfigured using the console port, the radio will, if necessary, be reconfigured.

Turning to the communications buffers processed at s.10.6, the communications buffers are barrel buffers and consist of a receive buffer and a transmit buffer for each communications port. The transmit buffers are trivial—they are polled every loop and if there is a character waiting to be transmitted, then it will be transmitted at the next opportunity. The receive buffers, of which there are 4 in the preferred embodiments, are a little more complex, as described next.

Communications buffer RX1 looks to see if a command is complete—if so it will set a flag so that it will be processed by the command parser. The commands are all related to module configuration.

Communications buffer RX2 contains characters received from the central site via the radio link. Currently these are not used or processed in any way, as the system is primarily for the remote units to feedback position data to the central hub unit. They are, however, available for DGNSS if required.

Communications buffer RX3 contains characters received from the GNSS receiver. The GNSS receiver is configured to output GGA strings. GGA strings are the raw 3D position fix and accuracy information, output from the GNSS module, and typically provided in the following format:

$GPGGA,123519,4807.038,N,01131.000,E,1,08,0.9,545.4,M,46.9,M,,*47

| Where: | | |
|---|---|---|
| GGA | Global Positioning System Fix Data | |
| 123519 | Fix taken at 12:35:19 UTC | |
| 4807.038,N | Latitude 48 deg 07.038′ N | |
| 01131.000,E | Longitude 11 deg 31.000′ E | |
| 1 | Fix quality: | 0 = invalid |
| | | 1 = GPS fix (SPS) |
| | | 2 = DGPS fix |
| | | 3 = PPS fix |
| | | 4 = Real Time Kinematic |
| | | 5 = Float RTK |
| | | 6 = estimated (dead reckoning) |
| | | (2.3 feature) |
| | | 7 = Manual input mode |
| | | 8 = Simulation mode |

| | |
|---|---|
| 08 | Number of satellites being tracked |
| 0.9 | Horizontal dilution of position |
| 545.4,M | Altitude, Meters, above mean sea level |
| 46.9,M | Height of geoid (mean sea level) above WGS84 |
| | ellipsoid |
| (empty field) | time in seconds since last DGPS update |
| (empty field) | DGPS station ID number |
| *47 | the checksum data, always begins with * |

These strings are of a fixed field length. In the RX3 buffer when the start of a string is detected, a number of counters are reset. These are used to count characters, and simply drop those which are redundant. All the remaining characters are numeric. The characters which are kept are held in the command buffer (the console interface and GNSS are mutually exclusive), and are shown in the table below. Once the GGA string has been completely received, the command buffer holds a truncated string, which still holds sufficient information to determine the location of a remote unit. If the appropriate configuration option has been selected, this truncated string is then compressed by converting the numeric value to a (4 bit) binary coded decimal (BCD) value, then packing the BCD digits.

For example, the buffer receives a raw GGA string from the GNSS receiver as:

### $GPGGA,111242.00,5127.414122,N,00113.601822.W,1,09,01.7,081.3,M,47.4,M,*44

which is 78 characters in length. After initial truncation when reading into the buffer (i.e. by dropping the unwanted characters) this results in a string stored in the buffer structured as:

| Char | | |
|---|---|---|
| Posn | Char | |
| 1 | 0xFE | Packet start |
| 2 | 0xnn | Unit ID, packed BCD |
| 3 | t | Time mmss.s no decimal point |
| 4 | t | Time mmss.s no decimal point |
| 5 | t | Time mmss.s no decimal point |
| 6 | t | Time mmss.s no decimal point |
| 7 | t | Time mmss.s no decimal point |
| 8 | x | Latitude mm.mmmmmm, no decimal point |
| 9 | x | Latitude mm.mmmmmm, no decimal point |
| 10 | x | Latitude mm.mmmmmm, no decimal point |
| 11 | x | Latitude mm.mmmmmm, no decimal point |
| 12 | x | Latitude mm.mmmmmm, no decimal point |
| 13 | x | Latitude mm.mmmmmm, no decimal point |
| 14 | x | Latitude mm.mmmmmm, no decimal point |
| 15 | x | Latitude mm.mmmmmm, no decimal point |
| 16 | y | Longitude mm.mmmmmm, no decimal point |
| 17 | y | Longitude mm.mmmmmm, no decimal point |
| 18 | y | Longitude mm.mmmmmm, no decimal point |
| 19 | y | Longitude mm.mmmmmm, no decimal point |
| 20 | y | Longitude mm.mmmmmm, no decimal point |
| 21 | y | Longitude mm.mmmmmm, no decimal point |
| 22 | y | Longitude mm.mmmmmm, no decimal point |
| 23 | y | Longitude mm.mmmmmm, no decimal point |
| 24 | 0x0A | Packet end |

And finally, after compression:

| Char | | |
|---|---|---|
| Posn | Char | |
| 1 | 0xFE | Packet start |
| 2 | 0xnn | Unit ID, packed BCD |
| 3 | 1 | mmss.sdd.ddddddee.eeeeee |
| 4 | 2 | mmss.sdd.ddddddee.eeeeee |
| 5 | 3 | mmss.sdd.ddddddee.eeeeee |
| 6 | 4 | mmss.sdd.ddddddee.eeeeee |
| 7 | 5 | mmss.sdd.ddddddee.eeeeee |
| 8 | 6 | mmss.sdd.ddddddee.eeeeee |
| 9 | 7 | mmss.sdd.ddddddee.eeeeee |
| 10 | 8 | mmss.sdd.ddddddee.eeeeee |
| 11 | 9 | mmss.sdd.ddddddee.eeeeee |
| 12 | 10 | mmss.sdd.ddddddee.eeeeee |
| 13 | 11 | mmss.sdd.ddddddee.eeeeee |
| 14 | 0x0A | Packet end |

Although further compression is possible, this approach represents a reasonable balance between processing complexity (and power consumption) and compression (in excess of five times smaller than the original string).

On completion of truncation and compression, the string is then sent to the radio for transmission, with the exception of the last character. This is sent as a trigger character to the radio, causing it to transmit the entire packet when its time slot in the TDMA frame is due.

RX buffer 4 is used for DGNSS and is not currently implemented.

### Interrupts

Interrupts are important to the entire system. The different types of interrupts are shown in FIG. 11. They are received from a number of sources:

The Comm n interrupts, where n is 1 to 4, (1108, 1110, 1112, and 1114) simply take a character from the UART buffer and put it in the appropriate barrel buffer, described above, with n indicating the buffer in which the character is to be placed.

The 1 PPS (1 pulse per second) interrupt (1104) is generated by the GNSS module. This derives its timing from the DGNSS system, thus synchronising all the remotes with the central site to within 25 ns. On receipt of the 1 PPS interrupt an offset value is loaded into a timer. The value of the offset is related to the remote station ID.

When the timer expires, (the first time after the 1 pps interrupt), it is re-loaded with a different value and the final character of the TDMA packet is sent to the radio. This triggers the radio to transmit the waiting packet. The new value loaded into the timer will cause an internal timer interrupt after 200 ms, when the next packet will be transmitted. The maximum temporal drift of an individual remote is therefore that of the internal clock of the processor in a one second period, which should be very small. Timing synchronisation of the various remote units and the central unit should therefore be readily maintained.

During the idle time between 200 ms interrupts, the next packet is being received, truncated and compressed.

The central site transmits a dummy string of characters during its TDMA slot (see FIG. 6). These are discarded by the remote units, the purpose of the central site transmission being to indicate the start of the TDMA frame. The remote units then transmit in their allocated slots in the TDMA frame in turn. Any received characters at the central site are passed straight to the console port, for processing by an external application.

The radio link runs at 38.4 kbps. Although higher speeds are available, the link budget infers that they are not used.

A tracker application is provided with the system, to provide basic mapping and logging facilities. In some embodiments it may be able to provide video feeds and system configuration utilities.

Various modifications may be made to the above described embodiment of the horse location tracking system 12 to provide further embodiments. For example, in one embodiment the remote units may determine the receive power of the burst received at the start of the TDMA frame from the central unit, and adapt their own transmit power in dependence thereon. The adaptation is generally such that it is inverse to the received power i.e. if the power or signal strength of the received burst from the central unit is lower than expected, then power or signal strength of the burst transmitted from the remote unit is increased. For example, if the power of the received burst is 2 dB less than a predetermined nominal expected receive power or strength value, then the transmit power or strength is increased by 2 dB. The reason for this is that receive power is likely less because the central unit is further away than expected, for example at the other end of a race-course. Therefore, to compensate for this extra distance and ensure that the transmitted signals are received at the central unit with the required signal-to-noise ratio the transmit signal power or strength is increased by the same amount.

In another embodiment the time slot width in the TDMA frame may be varied, for example to transmit less, or more data. For example, if there are fewer participants in an event, the time slots may be lengthened, so that more of the GGA data, for example, is included. Alternatively, other physiological or performance data may be included, for example from other sensors. For example, in one embodiment, heart rate data from a heart rate sensor, or performance data from an accelerometer may be included, if there is sufficient space within a particular time slot for inclusion.

In further embodiments, where there are fewer participants such that there are spare time slots in the TDMA frame, instead of lengthening the individual time slots to include more data the time slots may be kept the same length and the frame shortened so as to exclude the unused time slots. This allows the frame repetition rate to increase, such that the position refresh rate is increased. For example, in a system with 18 ms time slots over a 200 ms frame such that 9 participants can be tracked (allowing for 2 ms guard times) the total frame length is 200 ms, giving a 5 Hz refresh rate. However, if there are only four participants in a particular race then by preventing the provision of empty slots the total frame length can be reduced to 100 ms in length, thus giving a 10 Hz refresh rate.

Within the above described embodiments the frame length gives a maximum number of participants in an event that may be tracked, to allow for an adequate position refresh rate. For example, a 200 ms frame length gives a 5 Hz position refresh rate, which is deemed acceptable. Other refresh rates, for example as low as 2 or 3 Hz, may also be acceptable in some circumstances, depending on the event being monitored. Where the refresh rate can be lower, the frame length can be increased either to allow for more data to be transmitted from the same number of participants, or for the same amount of data to be transmitted by a greater number of participants.

In some embodiments, however, the refresh rate cannot be lowered sufficiently to allow the frame length to be increased to accommodate the number of participants in an event. In such circumstances multiple tracking systems as described above may be deployed in parallel, configured to operate on different frequencies, with the respective outputs of the individual systems then being multiplexed together to provide a single data stream or feed with position data for all the participants. For example, for a 40 horse race, such as the Aintree Grand National or the like, 4 or 5 systems may be deployed in parallel, with the respective systems set to operate on different non-interfering RF carrier frequencies, with each system handling 8 or 10 horses. The respective central units of the parallel systems then provide their respective serial feeds into a multiplexer unit, which interlaces the serial feeds together into a combined serial feed at a higher bit rate, for output via a network to consumers such as the race track mapping system or the like. By using such parallel systems and multiplexing the respective outputs together, the embodiments of the invention provide for a scalable tracking solution for any number of participants to be tracked in an event.

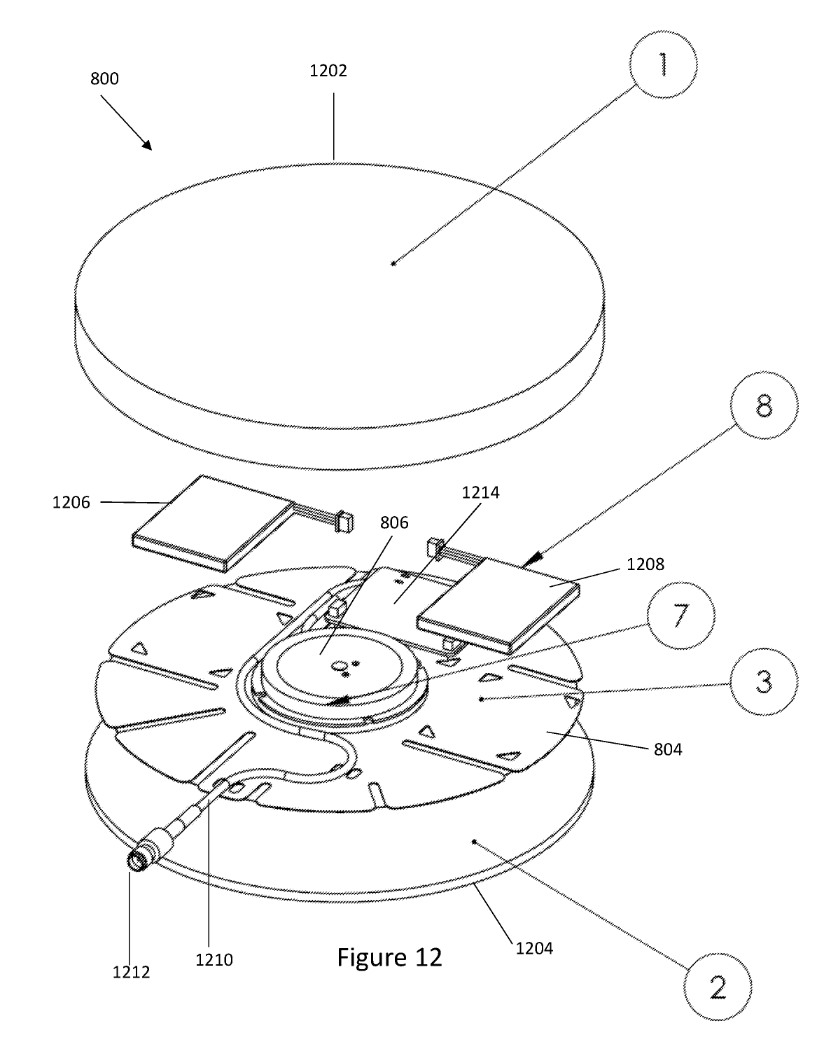

FIG. 12 shows an exploded view of a tracking device 800 according to an embodiment of the invention. The tracking device 800 corresponds at least to one of the remote units 52, described previously. The device comprises a casing which is made up of first (1202) and second (1204) parts. Each part has a substantially planar form and the two parts are configured to assemble together to form a substantially closed casing around the electronic components which provide the electronic functionality of the device. The components include one or more of a GNSS (Global Navigation System using Satellites) antenna 806, at least one battery 1206, which may be accompanied by a second or further batteries 1208. The number of batteries can be selected according to the desired battery life required for the device. A printed circuit board 1214 is included, on which is mounted the GNSS receiver 82, and which can also mount a radio module for transmitting data from the GNSS receiver to a remote system (typically central hub unit 54) via an antenna, which can be connected via an antenna conductor 1210 via an optional connector 1212. Alternatively, data can be transmitted via the connector 1212 for conversion to radio frequency signals at radio 88 externally to the device 800 (where radio 88 is located externally). This can permit the antenna and/or external transmitter module to be connected and disconnected from the main assembly of the device 800.

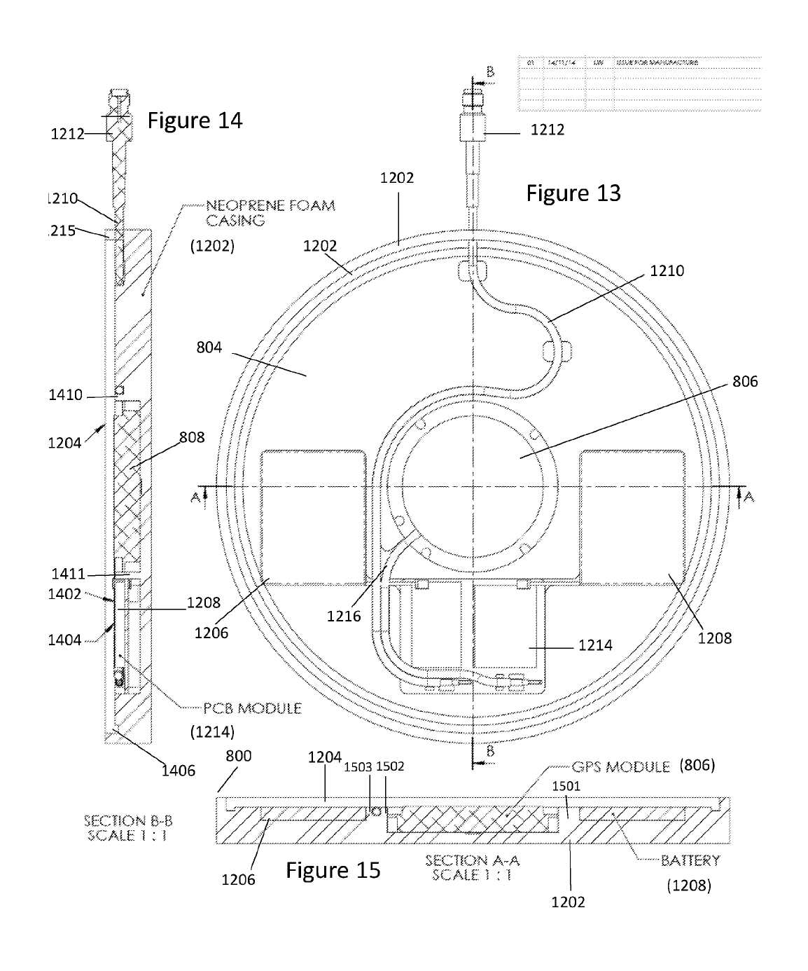

FIG. 13 shows a plan view of the internal components of the tracking device of the invention. Here it can be seen that the components are laid out in a substantially planar array, so that an aspect ratio, defined as a greatest width of the array in a direction of the plane of the device, relative to the depth of the array perpendicular to the plane of the array of the components, is very high. In the illustrated example, the ratio is approximately 14:1 but other ratios can be beneficial. For example, such aspect ratios anywhere above 5:1 or 8:1 or 10:1 can also be beneficial. These ratios can also beneficially be applied to the ratio of a width of the GNSS antenna and its ground plane to their overall height. The general planar form of the array of components is achieved by avoiding overlap of any of the principal electronic components shown in the figure. The only part of the assembly which has any significant overlap in the illustrated example is the antenna conductor 1210, which can overlap the Printed Circuit Board (PCB) 1214, to permit its connection thereto. Otherwise, the battery or batteries, GPS or GNSS antenna 806 and PCB 1214 are generally arranged adjacent one another in a substantially planar array.

The GNSS module may be any standard GNSS receiver which preferably offers multi-constellation single frequency tracking and preferably provides low power consumption. A specific example used in the preferred embodiment is the NV08C-CSM, GLONASS+GPS+GALILEO+SBAS module, which is suitable for use in various low cost low power consumption implementations. The product is manufactured by NVS Navigation Technologies Ltd. The GNSS module used in the invention preferably provides for a number of channels greater than 32 and is arranged to accommodate global navigation using satellites (GNSS) protocols which allow a satellite access mode of all satellites in view and uses GPS/GALILEO/SBAS L1 frequency 1575.42 Mhz and GLONASS L1 frequency 1597.5 to 1609.5 Mhz.

The batteries 1206 and 1208 in the illustrated example are 3.7 volt 800 mAH batteries, and one or more of these may be complemented by a 950 mAH battery for improved performance. A GNSS cable 1216 may be further provided to connect the GNSS antenna 806 to the PCB 1214, which may comprise GPS or GNSS electronics such as a GNSS receiver 82 as described above. The electrical components shown in FIG. 13 therefore each occupies a separate component receiving portion of the casing 1202 and may be received in recesses or cut-outs in the casing 1202. The casing comprises a central portion 804, where the components are accommodated. This may be surrounded by an outer wall 1215, which may project from the plane of the casing portion 1202 to provide a surrounding wall around the component receiving area 804. An opening may be provided in the wall 1215 to permit the antenna conductor 1210 to protrude through the wall 1215.

FIG. 14 shows a first side section through the assembly of FIG. 13. Here it can be seen that the first casing portion 1202 receives the electrical components such as GNSS or GPS antenna 806 and batteries 1208 in recesses formed in the first casing portion. The second casing portion 1204 is assembled to engage the wall portion 1215 and as can be understood, the first 1202 and second 1204 portions of the casing can be assembled together to create a substantially enclosed casing for the electronic components. The component 804 shown in FIG. 12 can be a chassis plate which may be made from any plastics material such as polypropylene and is preferably made from a flexible material to enable it to flex with the casing of the device. This is indicated as item 1402 in FIG. 14. To provide a ground plane for the GNSS antenna, a conductive sheet or plate, or a conductive mesh, may be applied to the chassis plate 1402 and is indicated at 1404 applied to the chassis plate 1402 in FIG. 14. The conductive mesh can therefore provide a ground plane for the GNSS antenna, while the chassis plate provides structural integrity to the assembly. There may further be provided a channel 1406 around a periphery of the first casing portion 1202, which can accommodate a lip provided on the second casing portion 1204, to provide a more secure mechanical engagement between the two casing parts.

FIG. 15 shows a further side section view through the device 800 of the invention. Here it can further be identified that the electronic components, here including the GPS antenna 806, and first 1206 and second 1208 batteries, are received in component-receiving portions of the casing, and enclosed therein by a second part of the casing 1204. It can further be seen in both FIGS. 14 and 15 that each of the electronic components can be separated by spacing portions 1501, 1502, 1503 in FIGS. 15 and 1410, 1411 in FIG. 14. These spacing portions can be arranged between components to prevent mechanical contact, and any resulting damage, between the components during vibration or flexure of the device as a whole. These spacing portions may be separate components or may be integrally formed with the casing, as illustrated in the drawings. The spacing portions may project between the component receiving portions of the casing.

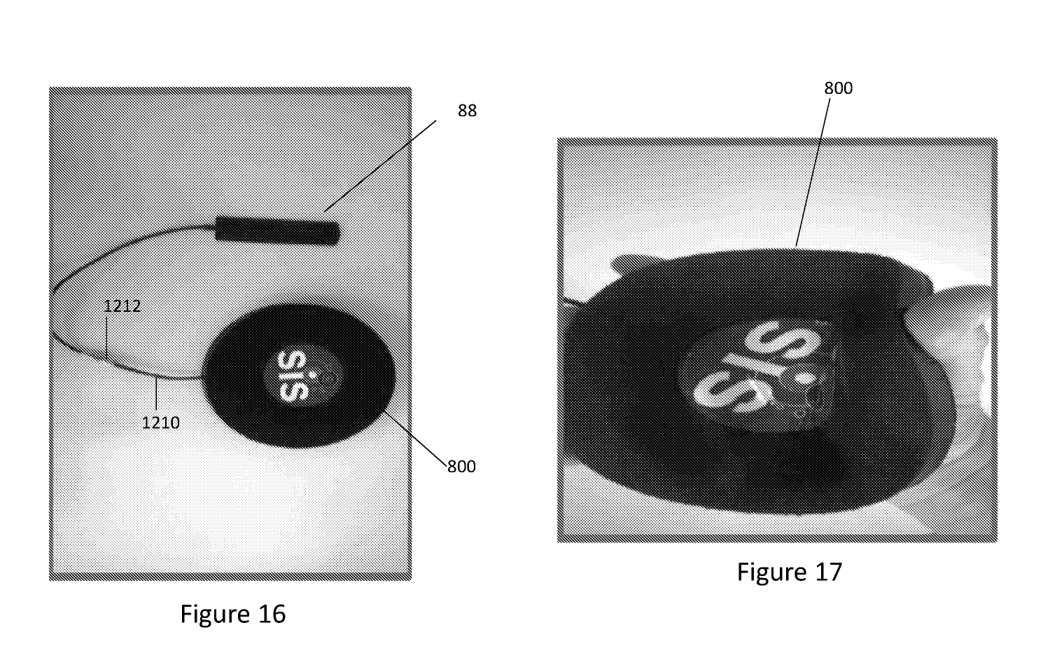

FIG. 16 shows device 800 of the invention in which an external antenna or transmission device 88 is connected via the data conductor 1210 and the data connector 1212. The conductor 1210 is preferably flexible and this can allow the module or antenna 88 to be spaced from and movable relative to the main portion of the device 800. This can improve reception and transmission of signals via the module 88 and can help to reduce any interference which can potentially occur between the electronics in the device and the radio frequency signals transmitted from the module 88.

As is illustrated in FIG. 17, the device 800 can be formed from a flexible casing and thus the device can be at least partially deformed as shown in the Figure without damage to the internal components, nor any significant negative effect on the performance of the device. This can be particularly advantageous in the implementations of the device which are considered herein, where the device is subject to a great deal of movement and vibration, potential impacts from the horse, or any other type of moving vehicle, and/or rider or jockey, or neighbouring competitors in a race.

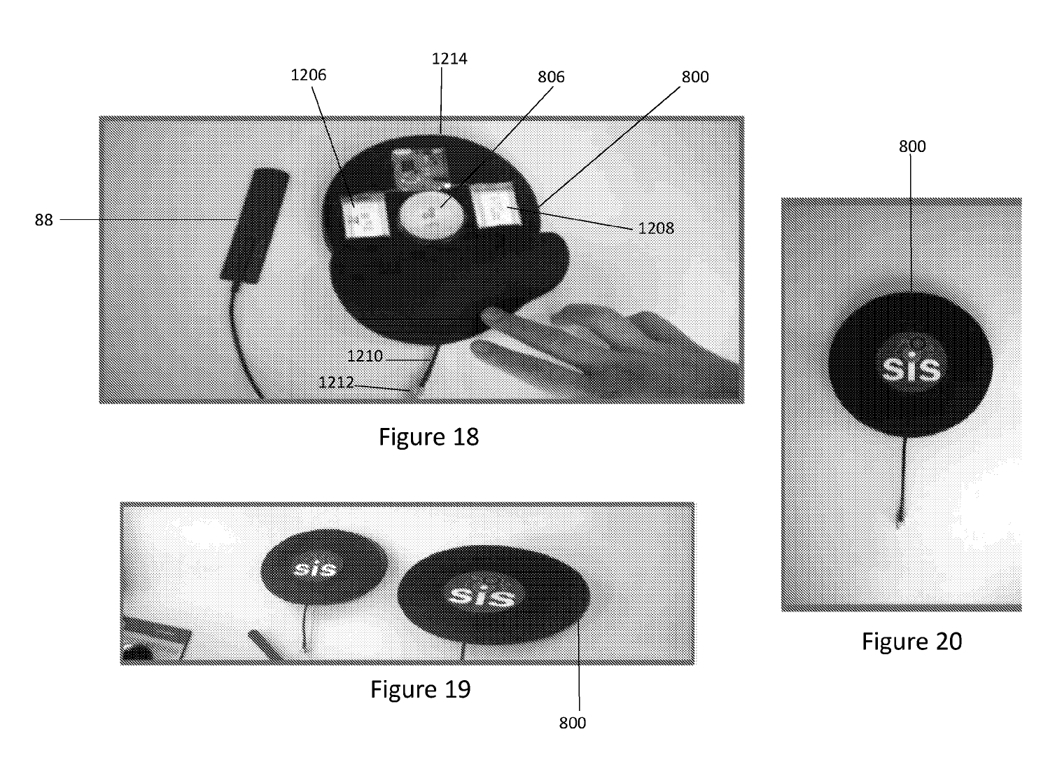

FIG. 18 shows a view in which the second casing portion 1204 has been partially peeled back to reveal internal components which are received in the first casing portion 1202. Here it can again be seen that received in the device 800 is the GNSS antenna 806, first and second batteries 1206 and 1208, and the PCB 1214 which can optionally include a radio transmitter module as well as the GNSS receiver, as described above. As shown previously, the external radio antenna 88 is connected via the antenna connector 1212 and antenna conductor 1210.

As shown in FIG. 19, the device of the invention can come in different sizes and configurations, depending upon the implementation and overall package used. A greater spacing between components may be desired in certain applications to allow greater flexure of the casing and its internal components as a whole and so a larger overall size of the array of components may be necessary. In other implementations, smaller components, less batteries, or potential stacking or overlapping of components may mean that the array can have a smaller overall planar dimension and can be contained in a device of smaller width or diameter. It can be seen in the drawings that the preferred embodiment comprises substantially disc-shaped first and second portions of the casing, however any outer form can be used whilst still providing the principal advantages of the invention described herein.

FIG. 20 shows the device 800 of the invention without the external antenna or module 88 being connected. The device can therefore be connected to any suitable data receiving device, or to an antenna and the device and/or external modules of the invention can be separately replaced or repaired, stored and carried in between uses.

In practice a larger antenna can provide better performance of the GPS or GNSS module of the invention. In the constraints of the casing of the example described, a large antenna is not always practical, either in terms of size or weight. In the device of the present invention, after some research and experimentation, it was found that the size, weight and performance could be significantly improved over either a large GNSS antenna, or a small patch antenna. This was done by using a relatively high performance antenna module, together with a flexible ground plane, moulded into the flexible casing described. The ground plane in this embodiment comprises a disc of thin plastic with metal mesh mounted on one side, so as to flexible. In other embodiments the GNSS antenna ground plane may be mesh per se i.e. without the plastic substrate, or a disc of thin conductive material, thin enough to be flexible. The purpose of the antenna ground plane is to act as a reflector for the antenna, thus giving the effect of a larger antenna than is otherwise provided. The provision of a simulated larger antenna via the provision of the ground plane gives a greater antenna gain and hence improved link budget for the GNSS data link, and overall results in improved GNSS performance, such as reduced time to fix, and position tracking.

In the shown embodiments the ground plane is between 2 and 4 times the diameter of the GNSS antenna per se, and in particular around 3 times the diameter of the GNSS antenna.

The preferred antenna for remote data transmission is preferably selected for size and performance—the illustrated antenna does not require a ground plane, is relatively thin and preferably flexible.

Although embodiments of the invention have been described above, it will be appreciated that various changes or modifications may be made without departing from the scope of the disclosure, as defined in the appended claims. It will also be apparent that features of these different embodiments can be combined both with one another and also with features of the prior art arrangements described herein in order to achieve the advantages of the disclosure.

1. A location determining device, comprising:
a GNSS receiver;
a controller; and
a wireless transceiver;
the controller being arranged to receive position data from the GNSS receiver, and to control the wireless transceiver to transmit at least a subset of the position data in a TDMA timeslot of a TDMA frame defined by receipt of a data burst from a separate transceiver to which the position data is to be transmitted.

2. A device according to claim 1, wherein the GNSS receiver passes GGA data strings to the controller, and the controller is arranged to truncate the received GGA data strings such that the position data transmitted consists essentially of time, latitude, and longitude data.

3. A device according to claim 2, wherein the transmitted position data is further compressed prior to transmission.

4. A device according to claim 1, wherein the TDMA timeslot position within the frame width is predefined in dependence on a number of remote units that need to transmit to the separate transceiver within the TDMA frame.

5. A device according to claim 1, wherein the TDMA timeslot width is predefined in dependence on a number of remote units that need to transmit to the separate transceiver within the TDMA frame.

6. A device according to claim 1, wherein the device also transmits data relating to any one or more of:
i) physiological data; or
ii) performance data
within the allocated TDMA time slot.

7. A device according to claim 1, and further arranged to detect a property of the received data burst from the separate transceiver, and to adapt a property of its own transmission in dependence thereon.

8. A device according to claim 7, wherein the detected property is the strength or power of the received data burst, and the adapted property is the strength or power of its own transmission.

9. A device, comprising,
a controller, and
a wireless transceiver;
the controller being arranged to control the wireless transceiver to transmit a data burst defining the start of a TDMA frame structure, the transceiver then listening throughout the frame structure to data bursts from remote units containing GNSS position data of the remote units, the controller acting to aggregate the respective position data and output it as a data feed.

10. A race event monitoring system, comprising:
a processor;
a computer readable storage medium storing one or more computer programs, the computer programs operable when executed by the processor to cause the processor to operate in accordance with the following method:
receive two-dimensional geographic location data relating to the location of participants in a race event on a race track hosting the event;
determine one-dimensional position data of the participants indicative of relative position of the participants along the race track between start and finish points of the race event; and
outputting the one-dimensional position data as a data feed.

11. A system according to claim 10, wherein the method steps are repeated throughout the duration of the race event to provide one-dimensional position data throughout the duration of the event.

12. A system according to claim 10, and further comprising using the one-dimensional position data to generate one or more race variables, comprising one or more of:
i) time expended;
ii) distance travelled;
iii) distance remaining;
iv) race speed; or
v) current speed.

13. A system according to claim 12, wherein the race variables are combined with a priori participant specific performance variables, to calculate a probability distribution matrix of possible race results.

14. A system according to claim 13, wherein the probability distribution matrix is used to calculate the probabilities of one or more of:
i) Who will finish in the quickest time (race winner);
ii) Who will finish in the three quickest times (to be placed);
iii) Horse A to finish quicker than horse B (match bet); or
iv) Who will finish quickest ignoring horse A (betting without the favourite).

15. A system according to claim 14, and further comprising providing the calculated probabilities to users over a network connection.

16.-36. (canceled)

37. A device according to claim 9, wherein the remote units include a location determining device, comprising:
a GNSS receiver;
a controller; and
a wireless transceiver;
the controller being arranged to receive position data from the GNSS receiver, and to control the wireless transceiver to transmit at least a subset of the position data in a TDMA timeslot of a TDMA frame defined by receipt of a data burst from a separate transceiver to which the position data is to be transmitted.

38. A system according to claim 10, wherein the two-dimensional geographic location data is received as the data feed from a device, comprising,
a controller, and
a wireless transceiver;
the controller being arranged to control the wireless transceiver to transmit a data burst defining the start of a TDMA frame structure, the transceiver then listening throughout the frame structure to data bursts from remote units containing GNSS position data of the remote units, the controller acting to aggregate the respective position data and output it as a data feed.

39. A system according to claim 10, wherein the two-dimensional geographic location data is received as the data feed from a device comprising,
a controller, and
a wireless transceiver,
the controller being arranged to control the wireless transceiver to transmit a data burst defining the start of a TDMA frame structure, the transceiver then listening throughout the frame structure to data bursts from remote units containing GNSS position data of the remote units, the controller acting to aggregate the respective position data and output it as a data feed,
wherein the remote units include a location determining device, comprising:
a GNSS receiver;
a controller; and
a wireless transceiver,
the controller being arranged to receive position data from the GNSS receiver, and to control the wireless transceiver to transmit at least a subset of the position data in a TDMA timeslot of a TDMA frame defined by receipt of a data burst from a separate transceiver to which the position data is to be transmitted.

40. A device according to claim 1, further comprising a GNSS antenna and a planar flexible GNSS antenna ground plane; the device comprising a flexible casing surrounding the internal electronics and the flexible chassis.

41. A device according to claim 40, wherein the internal electronics are mounted to a flexible chassis within the flexible casing.
